(19) United States
(12) Patent Application Publication
(10) Pub. No.: US 2007/0285779 A1
(43) Pub. Date: Dec. 13, 2007

(54) OPTICAL FILMS COMPRISING HIGH REFRACTIVE INDEX AND ANTIREFLECTIVE COATINGS

(76) Inventors: CHRISTOPHER B. WALKER, St. Paul, MN (US); Mark B. O'Neill, Stillwater, MN (US); Richard J. Pokorny, Maplewood, MN (US); Roger A. Mader, Stillwater, MN (US); David B. Olson, Marine on St. Croix, MN (US); Brant U. Kolb, Afton, MN (US)

Correspondence Address: 3M INNOVATIVE PROPERTIES COMPANY, PO BOX 33427, ST. PAUL, MN, 55133-3427, US

(21) Appl. No.: 11/556,432

(22) Filed: Nov. 3, 2006

Related U.S. Application Data
(60) Provisional application No. 60/804,591, filed on Jun. 13, 2006.
(60) Provisional application No. 60/806,017, filed on Jun. 28, 2006.

(51) Int. Cl. G02B 5/30

(52) U.S. Cl. 359/494; 359/483

(57) ABSTRACT

Reflective polarizing films comprising a preferably durable high refractive index layer.

### CROSS REFERENCE TO RELATED APPLICATIONS

This application claims the benefit of U.S. Provisional Application Ser. Nos. 60/804,591, filed Jun. 13, 2006; 60/806,017, filed Jun. 28, 2006; and claims priority to pending U.S. application Ser. No. 11/267,790, filed Nov. 5, 2005 and PCT Application No. US2005/045876, filed Dec. 19, 2005 and published as WO2006/073773.

### BACKGROUND

Various antireflective polymer films (“AR films”) have been described. The physical principles by which antireflection films and coatings function are well known. Several overviews can be found, for example, in Optical Engineering, S. Muskiant Ed, Vol. 6., Optical Materials, Chap. 7, p 161, 1985 and as shown in U.S. Pat. No. 3,833,368 to Land, et al. AR films are often constructed of alternating high and low refractive index (“RI”) polymer layers of the correct optical thickness. With regards to visible light, this thickness is on the order of one-quarter of the wavelength of the light to be reflected. The human eye is most sensitive to light around 550 nm. Therefore it is desirable to design the low and high index coating thicknesses in a manner that minimizes the amount of reflected light in this optical range (e.g. 3% or lower).

As described in Groh and Zimmerman, Macromolecules, Vol. 24 p. 6660 (1991), it is known that fluorine containing materials have a low refractive index and are therefore useful in the low refractive index layer of AR films.

Various AR coatings using fluoro(meth)acrylate polymers and fluorine containing materials have also been described. Although increased fluorine content decreases the refractive index of the low refractive index coating composition, the concurrent decrease in surface energy can result in poor coating and optical cosmetic properties as well as a loss in interfacial adhesion with the adjacent high refractive index layer. Also, highly fluorinated materials have been known to reduce the hardness and durability of the coating.

### SUMMARY OF THE INVENTION

Certain optical films such as reflective polarizing films are described that comprise a high refractive index layer preferably comprising surface modified inorganic nanoparticles (e.g. having refractive index of at least 1.60) dispersed in a crosslinked organic material. The high refractive index layer preferably comprises 5 vol-% to about 40 vol-% surface modified zirconia nanoparticles. The high refractive index layer can be disposed on one or both major surfaces. The preferred high refractive index layers do not reduce the gain.

### BRIEF DESCRIPTION OF THE DRAWINGS

FIG. 1 is a perspective view of an illustrative microstructure-bearing optical product of the present invention.

### DETAILED DESCRIPTION OF PREFERRED EMBODIMENTS OF THE INVENTION

The recitation of numerical ranges by endpoints includes all numbers subsumed within the range (e.g. the range 1 to 10 includes 1, 1.5, 3.33, and 10).

The phrase “free-radically polymerizable” refers to monomers, oligomers, and polymers having functional groups that participate in crosslinking reactions upon exposure to a suitable source of free radicals. Free-radically polymerizable group include for example (meth)acryl groups, —SH, allyl, or vinyl. The free-radically polymerizable group may be halogenated with for example fluorine such as in the case of —COCF═CH₂.

Preferred free-radically polymerizable monomer and oligomers typically comprise one on more “(meth)acryl” groups with includes (meth)acrylamides, and (meth)acrylates optionally substituted with for example fluorine and sulfur. A preferred (meth)acryl group is acrylate. Multi-(meth)acrylate materials comprise at least two polymerizable (meth)acrylate groups; whereas as mono-(meth)acrylate material has a single (meth)acrylate group. Alternatively, the multi-(meth)acrylate monomer can include two or more (meth)acrylate group at one end of the compound. The free-radically polymerizable fluoropolymers typically comprise functional groups that react with (meth)acrylate or other (meth)acryl groups.

As used herein, “wt-% solids” refers to the sum of the components with the exception of solvent. In some instances, wt-% solids of the polymerizable organic composition is described, referred to the sum of the components with the exception of solvent and inorganic (e.g. particle) materials.

Presently described are optical films having a high refractive index coating alone or in combination with a low refractive index coating thereby providing an antireflective film. In preferred embodiments, the high refractive index coating and/or antireflective film coating(s) provides an increase in gain and/or an increase in durability.

In general, optical films are light transmissible films. Many optical films are designed to modify the wave vectors and resultant ray paths of light passing through the film. This may be accomplished for example by incorporation of a microstructured surface, a matte surface, a specular surface as well as bulk diffusive properties.

Various light transmissive optical films are known including but not limited to, multilayer optical films, microstructured films such as retroreflective sheeting and brightness enhancing films, (e.g. reflective or absorbing) polarizing films, diffusive films, as well as (e.g. biaxial) retarder films and compensator films such as described in U.S. Patent Application Publication No. 2004/0184150, Jan. 29, 2004.

As used herein, the term “film” refers to a generally planar structure typically having a thickness substantially smaller (e.g. at least 10 times) than its width and length. The thickness of an optical film is typically at least 25 microns. Although the thickness can be as great as 3 cm for example, typically the film is less than 2 mm, and more typically less than 800 microns.

A preferred type of optical film includes a microstructured surface such as a plurality of prisms on the film surface such that the films can be used to redirect light through reflection and refraction (e.g. of a diffuse light source). Such films are known as brightness enhancing films and light management films.

A typical brightness enhancing film includes a microstructured surface having a regular repeating pattern of symmetrical tips and grooves. Other examples of groove patterns include patterns in which the tips and grooves are not symmetrical and in which the size, orientation, or distance between the tips and grooves is not uniform.

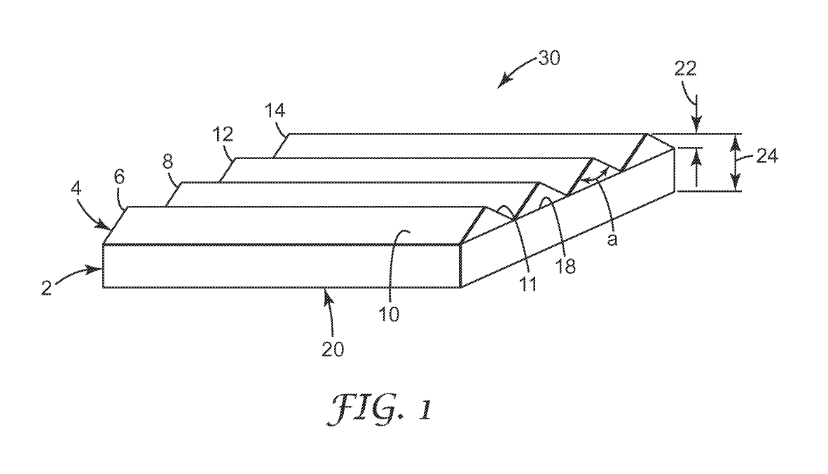

Referring to FIG. 1, a microstructured optical film 30 may comprise a base layer 2 and a microstructured optical layer 4. Alternatively, the microstructured optical film may be monolithic wherein the base layer and optical layer are comprised of the same material. Monolithic microstructured optical films can be prepared by known methods such as by extrusion of a molten thermoplastic resin. Optical layer 4 comprises a linear array of regular right prisms, identified as prisms 6, 8, 12, and 14. The height of the prisms typically ranges from about 1 to about 75 microns. Each prism, for example, prism 6, has a first facet 10 and a second facet 11. The prisms 6, 8, 12, and 14 are formed on base 2 that has a first surface 18 on which the prisms are formed and a second surface 20 that is substantially flat or planar and opposite first surface 18. By right prisms it is meant that the apex angle α is typically about 90°. However, this angle can range from 70° to 120° and may range from 80° to 100°. Further the apexes can be sharp, rounded, flattened or truncated. The apex angle of rounded prisms can be approximated by the intersection of the (e.g. flat) facets. The prism facets need not be identical, and the prisms may be tilted with respect to each other. The prism heights of the array may be substantially the same or may vary. The relationship between the total thickness 24 of the optical article, and the height 22 of the prisms, may vary. However, it is typically desirable to use relatively thinner optical layers with well-defined prism facets. A typical ratio of prism height 22 to total thickness 24 is generally between 25/125 and 2/125.

Provided that the optical film functions to redirect light, the surface structures may have varying pitch, intersecting channels, and/or varying prism angles. For example, the surface structures may have a pseudo-random prism undulation, such as described in U.S. Pat. No. 6,322,236. The surface structures may have more than three facets, and thus have other shapes such as pyramids. Further, the facets may be rounded facets and/or have other non-triangular shapes. Depending on the shape, the surface structures may be non-prismatic.

Many polymeric materials can be used as a base material and/or microstructured optical layer. Suitable materials are sufficiently optically clear and structurally strong to be assembled into or used within a particular optical product. Preferably, the base material is chosen that has sufficient resistance to temperature and aging that performance of the optical product is not compromised over time.

The particular chemical composition and thickness of the base material and/or microstructured optical layer can depend on the requirements of the particular optical product that is being constructed. That is, balancing the needs for strength, clarity, temperature resistance, surface energy, adherence to the optical layer, among others. The thickness of the base layer is typically at least about 0.025 millimeters (mm) and more typically at least about 0.125 mm. Further, the base layer generally has a thickness of no more than about 1 mm.

Useful base layer and/or microstructured optical layer materials include glass and various polymeric materials including cellulose acetate butyrate, cellulose acetate propionate, cellulose triacetate, polyether sulfone, polymethyl methacrylate, polyurethane, polyester, polycarbonate, polyvinyl chloride, syndiotactic polystyrene, polyethylene naphthalate, norbornene polymers, copolymers or blends based on naphthalene dicarboxylic acids. Optionally, the base material can contain mixtures or combinations of these materials. For example, the base may be multi-layered or may contain a dispersed phase suspended or dispersed in a continuous phase. Exemplary base layer materials include polyethylene terephthalate (PET) and polycarbonate. Examples of useful PET films include photograde polyethylene terephthalate (PET) and PET commercially available from DuPont Films of Wilmington, Del., under the trade designation “Melinex”.

Films produced from such base layer materials typically have some birefringence as a result of the film manufacturing process. Although microstructured optical films prepared from such base layers would also have such birefringence, such films are typically not characterized as polarizing films, since such optical films would not be employed as a polarizer in an illuminated (e.g. LCD) display. As used herein, “substantially non-polarizing optical film” refers to optical films whose diffuse reflectance varies by less than 0.5 as a function of polarization. Further, it is also common for a film (e.g. that is stretched during manufacturing) to have a higher index of refraction in one axis (e.g. machine direction) in comparison to a different axis (e.g. cross web direction).

In contrast “reflective polarizing optical film” refers to optical films whose diffuse reflectance varies by at least 0.05 as a function of polarization. Reflective polarizing optical films typically have a substantially higher reflectivity for one polarization mode than for another. Typically, the diffuse reflectance varies by at least 0.1 and more typically by at least 0.2 as a function of polarization.

Microstructured reflective polarizing optical films can be manufactured from a base layer material that is optically active, and can act as a polarizing material. A number of base layer materials are known to be useful as polarizing materials. Light polarization can also be achieved by including inorganic materials such as aligned mica chips or by a discontinuous phase dispersed within a continuous film, such as droplets of light modulating liquid crystals dispersed within a continuous film. As an alternative, a film can be prepared from microfine layers of different materials. The polarizing materials within the film can be aligned into a polarizing orientation, for example, by employing methods such as stretching the film, applying electric or magnetic fields, and coating techniques.

Examples of polarizing films include those described in U.S. Pat. Nos. 5,825,543 and 5,783,120. Multilayer polarizing films are sold by 3M Company, St. Paul, Minn. under the trade designation DBEF (Dual Brightness Enhancement Film). The use of such multilayer polarizing optical film in a brightness enhancement film has been described in U.S. Pat. No. 5,828,488; incorporated herein by reference. Other examples of polarizing films are described in U.S. Pat. Nos. 5,882,774, 5,965,247, 6,025,897. Other polarizing and non-polarizing films can also be useful as the base layer for brightness enhancing films of the invention such as described in U.S. Pat. Nos. 5,612,820 and 5,486,949, among others.

In one embodiment, the coating(s) are disposed on a surface of a reflective polarizing optical film, i.e. a film that transmits light of one polarization state and reflects light of a different polarization state. Examples of materials and constructions that achieve these desired functions can be found in, e.g., multilayer reflective polarizers, continuous/disperse phase reflective polarizers, cholesteric reflective polarizers (which may be combined with a quarter wave plate), and wire grid polarizers. In general, multilayer reflective polarizers and cholesteric reflective polarizers are specular reflectors and continuous/disperse phase reflective polarizers are diffuse reflectors, although these characterizations are not universal (see, e.g., the diffuse multilayer reflective polarizers described in U.S. Pat. No. 5,867,316). Also, the above list of illustrative reflective polarizing elements is not meant to be exhaustive of the reflective polarizing elements useful in connection with the present invention.

Both multilayer reflective polarizers and continuous/disperse phase reflective polarizers rely on index of refraction differences between at least two different materials (preferably polymers) to selectively reflect light of one polarization orientation while transmitting light with an orthogonal polarization orientation. Illustrative multilayer reflective polarizers are described in, e.g., PCT Publication Nos. WO95/17303; WO95/17691; WO95/17692; WO95/17699; and WO96/19347. One commercially available form of a multilayer reflective polarizer is marketed as Dual Brightness Enhanced Film (DBEF) by 3M Company, St. Paul, Minn.

Diffuse reflective polarizers useful in connection with the present invention include the continuous/disperse phase reflective polarizers described in, for example, U.S. Pat. No. 5,825,543 as well as the diffusely reflecting multilayer polarizers described in, e.g., U.S. Pat. No. 5,867,316. Other reflective polarizing elements useful in connection with the present invention are described in PCT Publication WO 96/31794.

Cholesteric reflective polarizers are also useful in connection with the present invention and are described in, e.g., U.S. Pat. No. 5,793,456. One cholesteric reflective polarizer is marketed under the tradename TRANSMAX™ by Merck Co. Wire grid polarizers may also be used and are described in, e.g., PCT Publication WO 94/11766.

The reflective polarizing optical films used in connection with the present invention may include specular reflective polarizers in which light having one polarization orientation is specularly reflected. The reflective polarizers may alternatively be diffuse reflective polarizers in which light having one polarization orientation is diffusely reflected.

As described in U.S. Patent Application 2003/0217806 multilayer optical films provide desirable transmission and/or reflection properties at least partially by an arrangement of microlayers of differing refractive index. The microlayers have different refractive index characteristics so that some light is reflected at interfaces between adjacent microlayers. The microlayers are sufficiently thin so that light reflected at a plurality of the interfaces undergoes constructive or destructive interference in order to give the film body the desired reflective or transmissive properties. For optical films designed to reflect light at ultraviolet, visible, or near-infrared wavelengths, each microlayer generally has an optical thickness (i.e., a physical thickness multiplied by refractive index) of less than about 1 μm. However, thicker layers can also be included, such as skin layers at the outer surfaces of the film, or protective boundary layers disposed within the film that separate packets of microlayers. Multilayer optical film bodies can also comprise one or more thick adhesive layers to bond two or more sheets of multilayer optical film in a laminate.

The reflective and transmissive properties of multilayer optical film body are a function of the refractive indices of the respective microlayers. Each microlayer can be characterized at least at localized positions in the film by in-plane refractive indices nₓ, n_{y}, and a refractive index n_{z} associated with a thickness axis of the film. These indices represent the refractive index of the subject material for light polarized along mutually orthogonal x-, y-, and z-axes. In practice, the refractive indices are controlled by judicious materials selection and processing conditions. Films can be made by co-extrusion of typically tens or hundreds of layers of two alternating polymers A, B, followed by optionally passing the multilayer extrudate through one or more multiplication die, and then stretching or otherwise orienting the extrudate to form a final film. The resulting film is composed of typically tens or hundreds of individual microlayers whose thicknesses and refractive indices are tailored to provide one or more reflection bands in desired region(s) of the spectrum, such as in the visible or near infrared. In order to achieve high reflectivities with a reasonable number of layers, adjacent microlayers preferably exhibit a difference in refractive index (δ nₓ) for light polarized along the x-axis of at least 0.05. If the high reflectivity is desired for two orthogonal polarizations, then the adjacent microlayers also preferably exhibit a difference in refractive index (δ n_{y}) for light polarized along the y-axis of at least 0.05. Otherwise, the refractive index difference can be less than 0.05 and preferably about 0 to produce a multilayer stack that reflects normally incident light of one polarization state and transmits normally incident light of an orthogonal polarization state. If desired, the refractive index difference (δ n_{z}) between adjacent microlayers for light polarized along the z-axis can also be tailored to achieve desirable reflectivity properties for the p-polarization component of obliquely incident light.

Exemplary materials that can be used in the fabrication of polymeric multilayer optical film can be found in PCT Publication WO 99/36248 (Neavin et al.). Desirably, at least one of the materials is a polymer with a stress optical coefficient having a large absolute value. In other words, the polymer preferably develops a large birefringence (at least about 0.05, more preferably at least about 0.1 or even 0.2) when stretched. Depending on the application of the multilayer film, the birefringence can be developed between two orthogonal directions in the plane of the film, between one or more in-plane directions and the direction perpendicular to the film plane, or a combination of these. In special cases where isotropic refractive indices between unstretched polymer layers are widely separated, the preference for large birefringence in at least one of the polymers can be relaxed, although birefringence is still often desirable. Such special cases may arise in the selection of polymers for mirror films and for polarizer films formed using a biaxial process, which draws the film in two orthogonal in-plane directions. Further, the polymer desirably is capable of maintaining birefringence after stretching, so that the desired optical properties are imparted to the finished film. A second polymer can be chosen for other layers of the multilayer film so that in the finished film the refractive index of the second polymer, in at least one direction, differs significantly from the index of refraction of the first polymer in the same direction. For convenience, the films can be fabricated using only two distinct polymer materials, and interleaving those materials during the extrusion process to produce alternating layers A, B, A, B, etc. Interleaving only two distinct polymer materials is not required, however. Instead, each layer of a multilayer optical film can be composed of a unique material or blend not found elsewhere in the film. Preferably, polymers being coextruded have the same or similar melt temperatures.

Exemplary two-polymer combinations that provide both adequate refractive index differences and adequate inter-layer adhesion include: (1) for polarizing multilayer optical film made using a process with predominantly uniaxial stretching, PEN/coPEN, PET/coPET, PEN/sPS, PET/sPS, PEN/Eastar™ and PET/Eastar™ where “PEN” refers to polyethylene naphthalate, “coPEN” refers to a copolymer or blend based upon naphthalene dicarboxylic acid, “PET” refers to polyethylene terephthalate, “coPET” refers to a copolymer or blend based upon terephthalic acid, “sPS” refers to syndiotactic polystyrene and its derivatives, and Eastar™ is a polyester or copolyester (believed to comprise cyclohexanedimethylene diol units and terephthalate units) commercially available from Eastman Chemical Co.; (2) for polarizing multilayer optical film made by manipulating the process conditions of a biaxial stretching process, PEN/coPEN, PEN/PET, PEN/PBT, PEN/PETG and PEN/PETcoPBT, where “PBT” refers to polybutylene terephthalate, “PETG” refers to a copolymer of PET employing a second glycol (usually cyclohexanedimethanol), and “PETcoPBT” refers to a copolyester of terephthalic acid or an ester thereof with a mixture of ethylene glycol and 1,4-butanediol; (3) for mirror films (including colored mirror films), PEN/PMMA, coPEN/PMMA, PET/PMMA, PEN/Ecdel™, PET/Ecdel™, PEN/sPS, PET/sPS, PEN/coPET, PEN/PETG, and PEN/THV™, where “PMMA” refers to polymethyl methacrylate, Ecdel™ is a thermoplastic polyester or copolyester (believed to comprise cyclohexanedicarboxylate units, polytetramethylene ether glycol units, and cyclohexanedimethanol units) commercially available from Eastman Chemical Co., and THV™ is a fluoropolymer commercially available from 3M Company.

Further details of suitable multilayer optical films and related constructions can be found in U.S. Pat. No. 5,882,774 (Jonza et al.), and PCT Publications WO 95/17303 (Ouderkirk et al.) and WO 99/39224 (Ouderkirk et al.). Polymeric multilayer optical films and film bodies can comprise additional layers and coatings selected for their optical, mechanical, and/or chemical properties. See U.S. Pat. No. 6,368,699 (Gilbert et al.). The polymeric films and film bodies can also comprise inorganic layers, such as metal or metal oxide coatings or layers.

The reflective polarizing optical film can further comprise a gain diffuser. One type of gain diffuser is described in U.S. Ser. No. 11/427,948, filed Jun. 30, 2006, incorporated herein by reference. The addition of beads in a binder, which is in the optical path of light being polarized by the reflective polarizing element, can provide some advantageous optical or mechanical properties. These properties include, for example, gain improvement, contrast improvement, reduction or elimination of wetting out and Newton's rings, diffusion, and color hiding or averaging. Preferably, the beads and binder have low birefringence and the beaded layer is polarization-preserving.

Typically, the beads contained in the beaded layer are solid articles that are substantially transparent and preferably transparent. They may be made of any suitable transparent material known to those of ordinary skill in the art, such as organic (e.g., polymeric) or inorganic materials. Some exemplary materials include, without limitation, inorganic materials, such as silica (e.g., Zeeospheres™, 3M Company, St. Paul, Minn.), sodium aluminosilicate, alumina, glass, talc, alloys of alumina and silica, and polymeric materials, such as liquid crystal polymers (e.g., Vectram™ liquid crystal polymer from Eastman Chemical Products, Inc., Kingsport, Tenn.), amorphous polystyrene, styrene acrylonitrile copolymer, cross-linked polystyrene particles or polystyrene copolymers, polydimethyl siloxane, crosslinked polydimethyl siloxane, polymethylsilsesquioxane and polymethyl methacrylate (PMMA), preferably crosslinked PMMA, or any suitable combinations of these materials. Other suitable materials include inorganic oxides and polymers that are substantially immiscible and do not cause deleterious reactions (degradation) in the material of the layer during processing of the particle-containing layers, are not thermally degraded at the processing temperatures, and do not substantially absorb light in the wavelength or wavelength range of interest.

The beads generally have a mean diameter in the range of, for example, 5 to 50 μm. Typically, the particles have a mean diameter in the range of 12 to 30 μm, or in some embodiments 12 to 25 μm. In at least some instances, smaller beads are preferred because this permits the addition of more beads per unit volume of the coating, often providing a rougher or more uniformly rough surface or more light diffusion centers. In some embodiments, the bead size distribution can be +/−50% and in other embodiments, it may be +/−40%. Other embodiments may include bead size distributions less than 40%, including a monodisperse distribution.

Although beads with any shape can be used, generally spherical beads are preferred in some instances, particularly for maximizing color hiding and gain. For surface diffusion, spherical particles give a large amount of surface relief per particle compared to other shapes, as non-spherical particles tend to align in the plane of the film so that the shortest principle axis of the particles is in the thickness direction of the film.

Typically, the binder of the beaded layer is also substantially transparent and preferably transparent. In most exemplary embodiments, the binder material is polymeric. Depending on the intended use, the binder may be an ionizing radiation curable (e.g., UV curable) polymeric material, thermoplastic polymeric material or an adhesive material. One exemplary UV curable binder may include urethane acrylate oligomer, e.g., Photomer™ 6010, available from Cognis Company.

A reflective polarizing optical film (i.e. without the antireflective or high refractive index coating) typically has a single sheet relative gain of at least 1.65. The relative single sheet gain is typically less than 1.80.

The addition of an antireflective film to an optical film such as brightness enhancing film can improve the gain. With reference to the Gain test Method described in the examples, an improvement of at least 0.01 to 0.02 or greater can be obtained.

The durable antireflective film comprises a relatively thick high refractive index layer in combination with a relatively thin low refractive index layer.

The term “low refractive index”, for the purposes of the present invention, shall mean a material when applied as a layer to a substrate forms a coating layer having a refractive index of less than about 1.5, and more preferably less than about 1.45, and most preferably less than about 1.42. The minimum refractive index of the low index layer is typically at least about 1.35.

The term “high refractive index”, for the purposes of the present invention, shall mean a material when applied as a layer to a substrate forms a coating layer having a refractive index of greater than about 1.5. The maximum refractive index of the high index layer is typically no greater than about 1.80. The difference in refractive index between the high index layer and low index layer is typically at least 0.15 and more typically 0.2 or greater.

The high refractive index layer typically has a thickness of at least 0.5 microns, preferably at least 1 micron, more preferably at least 2 micron and typically no greater than 10 microns. The low refractive index layer has an optical thickness of about ¼ wave or odd multiples of ¼ wave. Such thickness is typically less than 0.5 microns, more typically less than about 0.2 microns and often about 90 nm to 110 nm. When a durable high refractive index layer is employed in combination with a durable low refractive index layer, a durable (e.g. two-layer) antireflective film can be provided in the absence of additional hardcoat layers.

The low refractive index layer comprises the reaction product of free-radically polymerizable materials. In preferred embodiments, wherein the high refractive index layer comprises surface modified nanoparticles dispersed in a crosslinked organic material, the high refractive index layer also comprises the reaction product of free-radically polymerizable materials. The free-radically polymerizable material will be described herein with respect to (meth)acrylate materials. However, similar results can be obtained by the use of other free-radically polymerizable groups, as known in the art.

The low refractive index surface layer comprises the reaction product of a polymerizable low refractive index composition comprising at least one fluorinated free-radically polymerizable material and surface modified inorganic nanoparticles. The surface modified particles preferably having a low refractive index (e.g. less than 1.50) dispersed in a free-radically polymerized fluorinated organic material described herein. Various low refractive index inorganic oxides particles are known such as metal oxides, metal nitrides, and metal halides (e.g. fluorides). Preferred low refractive index particle include colloidal silica, magnesium fluoride, and lithium fluoride. Silicas for use in the low refractive index composition are commercially available from Nalco Chemical Co., Naperville, Ill. under the trade designation “Nalco Collodial Silicas” such as products 1040, 1042, 1050, 1060, 2327 and 2329. Suitable fumed silicas include for example, products commercially available from DeGussa AG, (Hanau, Germany) under the trade designation, “Aerosil series OX-50”, as well as product numbers-130, -150, and -200. Fumed silicas are also commercially available from Cabot Corp., Tuscola, I, under the trade designations CAB-O-SPERSE 2095”, “CAB-O-SPERSE A105”, and “CAB-O-SIL M5”.

The fluorinated component(s) of the low refractive index layer provide low surface energy. The surface energy of the low index coating composition can be characterized by various methods such as contact angle and ink repellency. The static contact angle with water of the cured low refractive index layer is typically at least 80°. More preferably, the contact angle is at least 90° and most preferably at least 100°. Alternatively, or in addition thereto, the advancing contact angle with hexadecane is at least 50° and more preferably at least 60°. Low surface energy is amenable to anti-soiling and stain repellent properties as well as rendering the exposed surface easy to clean.

In some embodiments, the antireflective films described herein are durable. In one aspect, the durable antireflective films resist scratching after repeated contact with an abrasive material such as steel wool. The presence of significant scratching can increase the haze of the antireflective film. In one embodiment, the antireflective film has a haze of less than 1.0% after 5, 10, 15, 20, or 25 wipes with steel wool using a 3.2 cm mandrel and a mass of 400 g, according to the Steel Wool Durability Test as further described in the examples.

Surface layers that resist visible scratching do not necessary retain their low surface energy. In preferred embodiments, the antireflective films also retain low surface energy after repeated contact with an abrasive material such as steel wool. In preferred embodiments, the antireflective film preferably exhibits an advancing contact angle with hexadecane of at least 45°, 50°, or 60° after 5, 10, 15, 20, or 25 wipes with steel wool using a 3.2 cm diameter mandrel and a mass of 400 grams, according to the Steel Wool Durability Testing. The antireflective film typically also exhibit a static contact angle with water of at least 90°, 95°, or 100° after 10 wipes, 50 wipes, 100 wipes, 200 wipes, or even 300 wipes with steel wool using a 3.2 cm diameter mandrel and a mass of 400 grams.

In some embodiments, durable antireflective film include the low refractive index layer as described herein in combination with a high refractive index layer that consists of a (e.g. single) thin layer of an inorganic material, such as a metal or metal oxide. Such high refractive index coatings are generally deposited by thermal evaporation, sputtering, or other vacuum deposition techniques. Examples of particular metal oxides include for example oxides of aluminum, silicon, tin, titanium, niobium, zinc, zirconium, tantalum, yttrium, cerium, tungsten, bismuth, indium, mixed oxides, and mixtures thereof.

The high refractive index layer of the durable antireflective film preferably comprises surface modified nanoparticles (preferably having a high refractive index of at least 1.60) dispersed in a crosslinked organic material. A variety of (e.g. non-fluorinated) free-radically polymerizable monomers, oligomers, polymers, and mixtures thereof can be employed in the organic material of the high refractive index layer. Preferably the organic material of high refractive index layer comprises a non-fluorinated free-radically polymerizable material having three or more (meth)acrylate groups alone or in combination with non-fluorinated monofunctional and/or difunctional materials, such as those subsequently described with respect to the low refractive index layer. Various suitable high refractive index compositions are known such as described in Pending U.S. application Ser. Nos. 11/026,573; 11/026,674; 11/026,702; all filed Dec. 30, 2004, and PCT Application Nos. US2005/045764; US2005/046526 and US2005/045876; incorporated herein by reference. Although fluorine atoms are not preferred for the high index layer, other halogens, such as bromine and iodine are useful, such as brominated (meth)acrylates.

Various high refractive index particles are known including for example zirconia (“ZrO₂”), titania (“TiO₂”), antimony oxides, alumina, and tin oxides, alone or in combination. Zirconias for use in the high refractive index layer are available from Nalco Chemical Co. under the trade designation “Nalco OOSSOO8” and from Buhler AG Uzwil, Switzerland under the trade designation “Buhler zirconia Z-WO sol”. Zirconia nanoparticle can also be prepared such as described in U.S. patent application Ser. No. 11/027,426 filed Dec. 30, 2004 and U.S. Pat. No. 6,376,590.

The concentration of (e.g. inorganic) nanoparticles in the low refractive index layer and/or the high refractive index layer is typically at least 5 vol-%, and preferably at least 15 vol-%. The concentration of inorganic particle is typically no greater than about 50 vol-%, and more preferably no greater than 40 vol-%.

The inorganic nanoparticles are preferably treated with a surface treatment agent. Surface-treating the nano-sized particles can provide a stable dispersion in the polymeric resin. Preferably, the surface-treatment stabilizes the nanoparticles so that the particles will be well dispersed in the polymerizable resin and results in a substantially homogeneous composition. Furthermore, the nanoparticles can be modified over at least a portion of its surface with a surface treatment agent so that the stabilized particle can copolymerize or react with the polymerizable resin during curing. The incorporation of surface modified inorganic particles is amenable to covalent bonding of the particles to the free-radically polymerizable organic components, thereby providing a tougher and more homogeneous polymer/particle network.

In general, a surface treatment agent has a first end that will attach to the particle surface (covalently, ionically or through strong physisorption) and a second end that imparts compatibility of the particle with the resin and/or reacts with resin during curing. Examples of surface treatment agents include alcohols, amines, carboxylic acids, sulfonic acids, phosphonic acids, silanes and titanates. The preferred type of treatment agent is determined, in part, by the chemical nature of the metal oxide surface. Silanes are preferred for silica and other for siliceous fillers. Silanes and carboxylic acids are preferred for metal oxides such as zirconia. The surface modification can be done either subsequent to mixing with the monomers or after mixing. It is preferred in the case of silanes to react the silanes with the particle or nanoparticle surface before incorporation into the resin. The required amount of surface modifier is dependant upon several factors such particle size, particle type, modifier molecular wt, and modifier type. In general it is preferred that approximately a monolayer of modifier is attached to the surface of the particle. The attachment procedure or reaction conditions required also depend on the surface modifier used. For silanes it is preferred to surface treat at elevated temperatures under acidic or basic conditions for from 1-24 hr approximately. Surface treatment agents such as carboxylic acids may not require elevated temperatures or extended time.

Representative embodiments of surface treatment agents suitable for the compositions include compounds such as, for example, isooctyl trimethoxy-silane, N-(3-triethoxysilylpropyl) methoxyethoxyethoxyethyl carbamate, N-(3-triethoxysilylpropyl) methoxyethoxyethoxyethyl carbamate, 3-(methacryloyloxy)propyltrimethoxysilane, 3-acryloxypropyltrimethoxysilane, 3-(methacryloyloxy)propyltriethoxysilane, 3-(methacryloyloxy) propylmethyldimethoxysilane, 3-(acryloyloxypropyl)methyldimethoxysilane, 3-(methacryloyloxy)propyldimethylethoxysilane, 3-(methacryloyloxy) propyldimethylethoxysilane, vinyldimethylethoxysilane, phenyltrimethoxysilane, n-octyltrimethoxysilane, dodecyltrimethoxysilane, octadecyltrimethoxysilane, propyltrimethoxysilane, hexyltrimethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, vinyltris(2-methoxyethoxy)silane, styrylethyltrimethoxysilane, mercaptopropyltrimethoxysilane, 3-glycidoxypropyltrimethoxysilane, acrylic acid, methacrylic acid, oleic acid, stearic acid, dodecanoic acid, 2-[2-(2-methoxyethoxy)ethoxy]acetic acid (MEEAA), beta-carboxyethylacrylate (BCEA), 2-(2-methoxyethoxy)acetic acid, methoxyphenyl acetic acid, and mixtures thereof.

The surface modification of the particles in the colloidal dispersion can be accomplished in a variety of known ways, such as described in previously cited U.S. patent application Ser. No. 11/027,426 filed Dec. 30, 2004 and U.S. Pat. No. 6,376,590; incorporated herein by reference. Zirconia nanoparticles are also commercially available from Nalco and Buhler.

A combination of surface modifying agents can be useful, wherein at least one of the agents has a functional group co-polymerizable with a hardenable resin. Combinations of surface modifying agent can result in lower viscosity. For example, the polymerizing group can be ethylenically unsaturated or a cyclic function subject to ring opening polymerization. An ethylenically unsaturated polymerizing group can be, for example, an acrylate or methacrylate, or vinyl group. A cyclic functional group subject to ring opening polymerization generally contains a heteroatom such as oxygen, sulfur or nitrogen, and preferably a 3-membered ring containing oxygen such as an epoxide.

A preferred combination of surface modifying agent includes at least one surface modifying agent having a functional group that is copolymerizable with the organic component of the polymerizable resin and a second modifying agent different than the first modifying agent. The second modifying agent is preferably a polyalkyleneoxide containing modifying agent that is optionally co-polymerizable with the organic component of the polymerizable composition.

Surface modified colloidal nanoparticles can be substantially fully condensed. Non-silica containing fully condensed nanoparticles typically have a degree of crystallinity (measured as isolated metal oxide particles) greater than 55%, preferably greater than 60%, and more preferably greater than 70%. For example, the degree of crystallinity can range up to about 86% or greater. The degree of crystallinity can be determined by X-ray diffraction techniques. Condensed crystalline (e.g. zirconia) nanoparticles have a high refractive index whereas amorphous nanoparticles typically have a lower refractive index.

The inorganic particles preferably have a substantially monodisperse size distribution or a polymodal distribution obtained by blending two or more substantially monodisperse distributions. Alternatively, the inorganic particles can be introduced having a range of particle sizes obtained by grinding the particles to a desired size range. The inorganic oxide particles are typically non-aggregated (substantially discrete), as aggregation can result in optical scattering (haze) or precipitation of the inorganic oxide particles or gelation. The inorganic oxide particles are typically colloidal in size, having an average particle diameter of 5 nanometers to 100 nanometers. The particle size of the high index inorganic particles is preferably less than about 50 nm in order to be sufficiently transparent. The average particle size of the inorganic oxide particles can be measured using transmission electron microscopy to count the number of inorganic oxide particles of a given diameter. The monomodal particle distribution is preferred for transparency.

The antireflective film may have a gloss or matte surface. Matte antireflective films typically have lower transmission and higher haze values than typical gloss films. For examples the haze is generally at least 5%, 6%, 7%, 8%, 9%, or 10% as measured according to ASTM D1003. Whereas gloss surfaces typically have a gloss of at least 130 as measured according to ASTM D 2457-03 at 60°; matte surfaces have a gloss of less than 120.

The surface can be roughened or textured to provide a matte surface. This can be accomplished in a variety of ways as known in the art including embossing the low refractive index surface with a suitable tool that has been bead-blasted or otherwise roughened, as well as by curing the composition against a suitable roughened master as described in U.S. Pat. No. 5,175,030 (Lu et al.) and U.S. Pat. No. 5,183,597 (Lu).

In yet another aspect, matte antireflective films can be prepared by providing the high refractive index layer and low refractive index (e.g. surface) layer on a matte film substrate. Exemplary matte films are commercially available from U.S.A. Kimoto Tech, Cedartown, Ga. under the trade designation “N4D2A”.

Matte low and high refractive index coatings can also be prepared by adding a suitably sized particle filler such as silica sand or glass beads to the composition. Such matte particles are typically substantially larger than the surface modified low refractive index particles. For example the average particle size typically ranges from about 1 to 10 microns. The concentration of such matte particles may range from at least 2 wt-% to about 10 wt-% or greater. At concentrations of less than 2 wt-% (e.g. 1.8 wt-%, 1.6 wt-%, 1.4 wt-%, 1.2 wt-%, 1.0 wt-%, 0.8 wt-%, 0.6 wt-%, the concentration is typically insufficient to produce the desired reduction in gloss (which also contributes to an increase in haze). However, durable antireflective films can be provided in the absence of such matte particles.

The low refractive index polymerizable composition and organic high refractive index polymerizable composition generally comprise at least one crosslinker having at least three free-radically polymerizable groups. This component is often a non-fluorinated multi-(meth)acrylate monomer. The inclusion of such material contributes to the hardness of the cured compositions.

The low refractive index and organic high refractive index polymerizable compositions typically comprises at least 5 wt-%, or 10 wt-%, or 15 wt-% of crosslinker. The concentration of crosslinker in the low refractive index composition is generally no greater than about 40 wt-%. For preferred embodiments that employ high concentration of inorganic particles, the concentration of crosslinker in the high refractive index composition is generally no greater than about 25 wt-%.

Suitable monomers include for example trimethylolpropane triacrylate (commercially available from Sartomer Company, Exton, Pa. under the trade designation “SR351”) ethoxylated trimethylolpropane triacrylate (commercially available from Sartomer Company, Exton, Pa. under the trade designation “SR454”), pentaerythritol tetraacrylate, pentaerythritol triacrylate (commercially available from Sartomer under the trade designation “SR444”), dipentaerythritol pentaacrylate (commercially available from Sartomer under the trade designation “SR399”), ethoxylated pentaerythritol tetraacrylate, ethoxylated pentaerythritol triacrylate (from Sartomer under the trade designation “SR494”) dipentaerythritol hexaacrylate, and tris(2-hydroxy ethyl) isocyanurate triacrylate (from Sartomer under the trade designation “SR368”). In some aspects, a hydantoin moiety-containing multi-(meth)acrylates compound, such as described in U.S. Pat. No. 4,262,072 (Wendling et al.) is employed.

The low and high refractive index polymerizable coating compositions may further comprise at least one difunctional (meth)acrylate monomer. Various difunctional (meth)acrylate monomers are known in the art, including for example 1,3-butylene glycol diacrylate, 1,4-butanediol diacrylate, 1,6-hexanediol diacrylate, 1,6-hexanediol monoacrylate monomethacrylate, ethylene glycol diacrylate, alkoxylated aliphatic diacrylate, alkoxylated cyclohexane dimethanol diacrylate, alkoxylated hexanediol diacrylate, alkoxylated neopentyl glycol diacrylate, caprolactone modified neopentylglycol hydroxypivalate diacrylate, caprolactone modified neopentylglycol hydroxypivalate diacrylate, cyclohexanedimethanol diacrylate, diethylene glycol diacrylate, dipropylene glycol diacrylate, ethoxylated bisphenol A diacrylate, neopentyl glycol diacrylate, polyethylene glycol diacrylate, (Mn=200 g/mole, 400 g/mole, 600 g/mole), propoxylated neopentyl glycol diacrylate, tetraethylene glycol diacrylate, tricyclodecanedimethanol diacrylate, triethylene glycol diacrylate, and tripropylene glycol diacrylate.

The low refractive index layer preferably comprises one or more free-radically polymerizable materials having a fluorine content of at least 25 wt-%. Highly fluorinated monomer, oligomers, and polymers are characterized by having a low refractive index. Various fluorinated multi- and mono-(meth)acrylate materials having a fluorine content of at least about 25 wt-% are known. In some embodiments, the low refractive polymerizable composition has a fluorine content of at least 30 wt-%, at least 35 wt-%, at least 40 wt-%, at least 45 wt-%, or at least 50 wt-%. Typically, a major portion of the high fluorinated material is a multifunctional free-radically polymerizable material. However, such materials can be used in combination with fluorinated mono-functional materials.

Various fluorinated mono- and multi-(meth)acrylate compounds may be employed in the preparation of the polymerizable low refractive index coating composition. Such materials generally comprises free-radically polymerizable moieties in combination with (per)fluoropolyether moieties, (per)fluoroalkyl moieties, and (per)fluoroalkylene moieties. Within each of these classes are species having a high fluorine content, (e.g. of at least 25 wt-%). Other species within each class, having fluorine content less than 25 wt-%, can be employed as auxillary components.

In some embodiments, such auxiliary fluorinated (meth)acrylate monomers can aid in compatibilizing the low refractive index or other fluorinated materials present in the reaction mixture. For example, perfluoropolyether urethane compounds have been found to be particularly useful for compatiblizing high fluorine containing materials such as described in U.S. patent application Ser. No. 11/087,413, filed Mar. 23, 2005; U.S. application Ser. No. 11/277,162, filed Mar. 22, 2006; and concurrently filed Docket No. 62060US002. Such perfluoropolyether urethane compounds generally include at least one polymerizable (e.g. terminal) (meth)acrylate moiety and at least one (optionally repeating) unit including a (per)fluoropolyether group bonded by means of a linking group having a valency of at least two to a urethane or urea linkage. The urethane and urea linkage is typically —NHC(O)X— wherein X is O, S or NR; and R is H or an alkyl group having 1 to 4 carbon. The perfluoropolyether moiety is preferably a HFPO— moiety, as previously described. One exemplary high fluorine perfluropolyether urethane (meth)acrylate is HFPO—C(O)NHC₂H₄OC(O)NHC₂H₄OC(O)C(CH₃)═CH₂, wherein HFPO is F(CF(CF₃)CF₂O)aCF(CF₃)— and “a” averages 2 to 15.

In preferred embodiments, the low refractive index polymerizable composition comprises at least one free-radically polymerizable fluoropolymer. A general description and preparation of these classes of fluoropolymers can be found in Encyclopedia Chemical Technology, Fluorocarbon Elastomers, Kirk-Othmer (1993), or in Modern Fluoropolymers, J. Scheirs Ed, (1997), J Wiley Science, Chapters 2, 13, and 32. (ISBN 0-471-97055-7).

Preferred fluoropolymers are formed from the constituent monomers known as tetrafluoroethylene (“TFE”), hexafluoropropylene (“HFP”), and vinylidene fluoride (“VDF,” “VF2,”). The monomer structures for these constituents are shown below:

TFE: CF₂═CF₂ (1)

VDF: CH₂═CF₂ (2)

HFP: CF₂═CF—CF₃ (3)

The fluoropolymers preferably comprise at least two of the constituent monomers (HFP and VDF), and more preferably all three of the constituents monomers in varying molar amounts. Additional monomers not depicted in (1), (2) or (3) but also useful include perfluorovinyl ether monomers of the general structure CF₂═CF—OR_{f}, wherein R_{f} can be a branched or linear perfluoroalkyl radicals of 1-8 carbons and can itself contain additional heteroatoms such as oxygen. Specific examples are perfluoromethyl vinyl ether, perfluoropropyl vinyl ethers, perfluoro(3-methoxy-propyl) vinyl ether. Additional examples are found in Worm (WO 00/12574), assigned to 3M, and in Carlson (U.S. Pat. No. 5,214,100).

Amorphous copolymers consisting of VDF-HFP and optionally TFE are hereinafter referred to as FKM, or FKM elastomers as denoted in ASTM D 1418. FKM elastomers have the general formula:

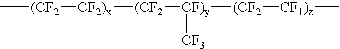

wherein x, y and z are expressed as molar percentages. In some embodiments, x can be zero so long as the molar percentage of y is sufficiently high (typically greater than about 18 molar percent) to render the microstructure amorphous. Additional fluoroelastomer compositions useful in the present invention exist where x is greater than zero.

The fluoropolymer comprises free-radically polymerizable groups. This can be accomplished by the inclusion of halogen-containing cure site monomers (“CSM”) and/or halogenated endgroups, which are interpolymerized into the polymer using numerous techniques known in the art. These halogen groups provide reactivity towards the other components of coating mixture and facilitate the formation of the polymer network. Useful halogen-containing monomers are well known in the art and typical examples are found in U.S. Pat. No. 4,214,060 to Apotheker et al., European Patent No. EP398241 to Moore, and European Patent No. EP407937B1 to Vincenzo et al. Optionally halogen cure sites can be introduced into the polymer structure via the use of halogenated chain transfer agents which produce fluoropolymer chain ends that contain reactive halogen endgroups. Such chain transfer agents (“CTA”) are well known in the literature and typical examples are: Br—CF₂CF₂—Br, CF₂Br₂, CF₂I₂, CH₂I₂. Other typical examples are found in U.S. Pat. No. 4,000,356 to Weisgerber. Whether the halogen is incorporated into the polymer microstructure by means of a cure site monomer or chain transfer agent or both is not particularly relevant as both result in a fluoropolymer which is more reactive towards UV crosslinking and coreaction with other components of the network such as the acrylates. An advantage to use of cure site monomers in forming the co-crosslinked network, as opposed to a dehydrofluorination approach (discussed below), is that the optical clarity of the formed polymer layer is not compromised since the reaction of the acrylate and the fluoropolymer does not rely on unsaturation in the polymer backbone in order to react. Thus, a bromo-containing fluoroelastomer such as Dyneon E-15742, E-18905, or E-18402 available from Dyneon LLC of St. Paul, Minn., may be used in conjunction with, or in place of, FKM as the fluoropolymer.

In another embodiment, the fluoropolymer can be rendered reactive by dehydrofluorinated by any method that will provide sufficient carbon-carbon unsaturation of the fluoropolymer to create increased bond strength between the fluoropolymer and a hydrocarbon substrate or layer. The dehydrofluorination process is a well-known process to induced unsaturation and it is used most commonly for the ionic crosslinking of fluoroelastomers by nucleophiles such as diphenols and diamines. This reaction is characteristic of VDF containing elastomers. A descriptions can be found in The Chemistry of Fluorocarbon Elastomer, A. L. Logothetis, Prog. Polymer Science (1989), 14, 251. Furthermore, such a reaction is also possible with primary and secondary aliphatic monofunctional amines and will produce a DHF-fluoropolymer with a pendent amine side group. However, such a DHF reaction is not possible in polymers which do not contain VDF units since they lack the ability to lose HF by such reagents.

Combinations of fluoropolymers rendered reactive by inclusion of a cure site monomer and fluoropolymers rendered reactive by dehydrofluorination can by employed. The fluoropolymer containing low refractive index composition described herein preferably comprise at least one amino organosilane ester coupling agent or a condensation product thereof as described in Ser. No. 11/026,640, filed Dec. 30, 2004; incorporated herein by reference. Preferred amino organosilane ester coupling agent include 3-aminopropyltrimethoxysilane, 3-aminopropyltriethoxysilane, (amino ethylaminomethyl)phenethyltrimethoxysilane, (aminoethylaminomethyl)phenethyltriethoxysilane, N-(2-aminoethyl)-3-aminopropylmethyldimethoxysilane, N-(2-aminoethyl)-3-aminopropylmethyldiethoxysilane, N-(2-aminoethyl)-3-aminopropyltrimethoxysilane, N-(2-aminoethyl)-3-aminopropyltriethoxysilane, 4-aminobutyltrimethoxysilane, 4-aminobutyltriethoxysilane, 3-aminopropylmethyldiethoxysilane, 3-aminopropylmethyldimethoxysilane, 3-aminopropyldimethylmethoxysilane, 3-aminopropyldimethylethoxysilane, 2,2-dimethoxy-1-aza-2-silacyclopentane-1-ethanamine, 2,2-diethoxy-1-aza-2-silacyclopentane-1-ethanamine, 2,2-diethoxy-1-aza-2-silacyclopentane, 2,2-dimethoxy-1-aza-2-silacyclopentane, 4-aminophenyltrimethoxy silane, and 3-phenylaminopropyltrimethoxy silane.

In another embodiment, the low refractive index layer comprises the reaction product of a A) fluoro(meth)acrylate polymeric intermediate and B) at least one fluorinated (meth)acrylate monomer as described in concurrently filed Docket No. 61846US002; incorporated herein by reference. The mixture of A) and B) is preferably cured by exposure to (e.g. ultraviolet light) radiation. The cured low refractive index polymeric composition may comprise copolymerization reaction products of A) and B). The cured low refractive index polymeric composition is surmised to also comprise polymerization products of B). The fluoro (meth)acrylate polymer intermediate may covalently bond to other components within the low refractive index coating composition. Further, other optional components of the low refractive index coating, e.g. such as non-fluorinated crosslinker, may polymerize physically entangling the fluoro (meth)acrylate polymer intermediate thereby forming an interpenetrating network.

The A) fluoro (meth)acrylate polymeric intermediate comprises the reaction product of i) at least one fluorinated multi-(meth)acrylate monomer or oligomer having a fluorine content of at least about 25 wt-%; and ii) optionally one or more fluorinated or non-fluorinated multi-(meth)acrylate materials. The optional multi-(meth) acrylate material may include a monomer, oligomer, polymer, surface modified inorganic nanoparticles having multi-(meth)acrylate moieties, as well as the various combinations of such materials. The total amount of multi-(meth)acrylate materials is generally at least 25 wt-% based on wt-% solids of the polymerizable organic composition. The total amount of multi-(meth)acrylate materials may range from about 30 wt-% to 70 wt-% of the nanopartilce containing composition.

The low refractive index composition may comprise various monofunctional and/or multi-functional HFPO-perfluoropolyether compounds. The inclusion of at least about 5 wt-% to about 10 wt-%, low surface energy surfaces can be provided having an initial static contact angel with water of at least 110°.

Various perfluoropolyether mono-(meth)acrylate compounds are known. One such exemplary low refractive index material is HFPO—C(O)NHCH₂CH₂OC(O)CH═CH₂, calculated to have 62.5 wt-% F. Other low refractive index perfluoropolyether mono-(meth)acrylate compounds that can be prepared in a similar manner are HFPO—C(O)NHCH₂CH₂OCH₂CH₂OCH₂CH₂OC(O)CH═CH₂ calculated to have 59.1 wt-% F, HFPO—C(O)NH(CH₂)₆OC(O)CH═CH₂ calculated to have 60.2 wt-% F, and HFPOC(O)NHCH₂CH₂OCH₂CH₂OCH₂CH₂OCH₂CH₂OC(O)CH═CH₂ calculated to have 57.3 wt-% F. Such compounds are described in U.S. patent application Ser. No. 11/277,162 filed Mar. 22, 2006 (See preparations 31a-31d).

An exemplary low refractive index perfluoropolyether multi-(meth)acrylate monomer is HFPO—C(O)N(H)CH₂CH(OC(O)CH═CH₂)CH₂OC(O)CH═CH₂, calculated to have a fluorine content of 53.4%. This monomer can be prepared as described as described in U.S. Patent Application Publication No. 2005/0249940-A1. (See FC-4). Other low refractive index multi-(meth)acrylate perfluoropolyether compounds include H₂C═CHC(O)OCH₂CH₂N(H)(O)C—HFPO—C(O)N(H)CH₂CH₂OC(O)CH═CH₂, having 58.1% fluorine and (H₂C═CHC(O)OCH₂)₂CH₃CH₂CN(H)(O)C—HFPOC(O)N(H)CCH₂CH₃(CH₂OC(O)CH═CH₂)₂ having 50.1% fluorine. These compounds can be prepared as described in the U.S. patent application Ser. No. 11/087,413, filed Mar. 23, 2005 and Pending U.S. application Ser. No. 11/277,162, filed Mar. 22, 2006 (See Preparations No. 28. and 30).

At least one free-radical initiator is typically utilized for the preparation of the polymerizable low and high refractive coating compositions. Useful free-radical thermal initiators include, for example, azo, peroxide, persulfate, and redox initiators, and combinations thereof. Useful free-radical photoinitiators include, for example, those known as useful in the UV cure of acrylate polymers. In addition, other additives may be added to the final composition. These include but are not limited to resinous flow aids, photostabilizers, high boiling point solvents, and other compatibilizers well known to those of skill in the art.

The polymerizable compositions can be formed by dissolving the free-radically polymerizable material(s) in a compatible organic solvent at a concentration of about 1 to 10 percent solids. A single organic solvent or a blend of solvents can be employed. Depending on the free-radically polymerizable materials employed, suitable solvents include alcohols such as isopropyl alcohol (IPA) or ethanol; ketones such as methyl ethyl ketone (MEK), methyl isobutyl ketone (MIBK), diisobutyl ketone (DIBK); cyclohexanone, or acetone; aromatic hydrocarbons such as toluene; isophorone; butyrolactone; N-methylpyrrolidone; tetrahydrofuran; esters such as lactates, acetates, including propylene glycol monomethyl ether acetate such as commercially available from 3M under the trade designation “3M Scotchcal Thinner CGS10” (“CGS10”), 2-butoxyethyl acetate such as commercially available from 3M under the trade designation “3M Scotchcal Thinner CGS50” (“CGS50”), diethylene glycol ethyl ether acetate (DE acetate), ethylene glycol butyl ether acetate (EB acetate), dipropylene glycol monomethyl ether acetate (DPMA), iso-alkyl esters such as isohexyl acetate, isoheptyl acetate, isooctyl acetate, isononyl acetate, isodecyl acetate, isododecyl acetate, isotridecyl acetate or other iso-alkyl esters; combinations of these and the like.

Although various fluorinated solvents could be employed, in one aspect compatible low refractive index coating compositions are prepared that are free of fluorinated solvents. Compatible coating compositions are clear, rather than hazy. Compatible coatings are substantially free of visual defects. Visual defects that may be observed when incompatible coating are employed include but are not limited to haze, pock marks, fisheyes, mottle, lumps or substantial waviness, or other visual indicators known to one of ordinary skill in the art in the optics and coating fields.

The method of forming an antireflective coating on an optical display or an antireflective film for use of an optical display may include providing a light transmissible substrate layer, such as a reflective polarizing film; providing a high refractive index material on the substrate layer; and providing the low index layer described herein coupled to the high refractive index layer. The low index layer may be provided by applying a layer of said low refractive index material onto said (e.g. cured) layer of said high refractive index material and irradiating with a sufficient ultraviolet radiation to crosslink. Alternatively, the low refractive index coating may be applied to a release liner, at least partially cured, and transfer coated. Further, the antireflection material may be applied directly to the substrate or alternatively applied to a release layer of a transferable antireflection film and subsequently transferred from the release layer to the substrate using a thermal transfer or photoradiation.

The low refractive index composition and high refractive index composition can be applied as a single or multiple layers to a high refractive index layer or directly to a (e.g. display surface or film) substrate using conventional film application techniques. Alternatively, the low refractive index coating may be applied to a release liner or substrate, at least partially cured, and transfer coated using a thermal transfer or photoradiation application technique. Although it is usually convenient for the substrate to be in the form of a roll of continuous web, the coatings may be applied to individual sheets. Advantageously, a combination of low reflectance and good durability can be obtained with a single low refractive index layer provided on a single high refractive index layer.

Thin films can be applied using a variety of techniques, including dip coating, forward and reverse roll coating, wire wound rod coating, and die coating. Die coaters include knife coaters, slot coaters, slide coaters, fluid bearing coaters, slide curtain coaters, drop die curtain coaters, and extrusion coaters among others. Many types of die coaters are described in the literature such as by Edward Cohen and Edgar Gutoff, Modern Coating and Drying Technology, VCH Publishers, NY 1992, ISBN 3-527-28246-7 and Gutoff and Cohen, Coating and Drying Defects: Troubleshooting Operating Problems, Wiley Interscience, NY ISBN 0-471-59810-0.

The low refractive index as well as high refractive index coating composition are dried in an oven to remove the solvent and then cured for example by exposure ultraviolet radiation using an H-bulb or other lamp at a desired wavelength, preferably in an inert atmosphere (less than 50 parts per million oxygen). The reaction mechanism causes the free-radically polymerizable materials to crosslink.

While the invention has been described in terms of preferred embodiments, it will be understood, of course, that the invention is not limited thereto since modifications may be made by those skilled in the art, particularly in light of the foregoing teachings.

### Test Methods

### Steel Wool Durability Test

The abrasion resistance of the cured films was tested cross-web to the coating direction by use of a mechanical device capable of oscillating a steel wool sheet adhered to stylus across the film's surface. The stylus oscillated over a 60 mm wide sweep width at a rate of 210 mm/sec (3.5 wipes/sec) wherein a “wipe” is defined as a single travel of 60 mm. The stylus had a flat, cylindrical base geometry with a diameter of 3.2 cm. The stylus was designed for attachment of weights to increase the force exerted by the steel wool normal to the film's surface. The #0000 steel wool sheets were “Magic Sand-Sanding Sheets” available from Hut Products Fulton, Mo. The #0000 has a specified grit equivalency of 600-1200 grit sandpaper. The 3.2 cm steel wool discs were die cut from the sanding sheets and adhered to the 3.2 cm stylus base with 3M Brand Scotch Permanent Adhesive Transfer tape. A single sample was tested for each example, with a 400 g weight and the number of wipes employed during testing as reported. The sample was then visually inspected for scratches. Ink repellency and contact angle was also evaluated.

### Gain Test Method

Optical performance of the films was measured using a SpectraScan™ PR-650 SpectraColorimeter with an MS-75 lens, available from Photo Research, Inc, Chatsworth, Calif. The films were placed on top of a diffusely transmissive hollow light box. The diffuse transmission and reflection of the light box can be described as Lambertian. The light box was a six-sided hollow cube measuring approximately 12.5 cm×12.5 cm×11.5 cm (L×W×H) made from diffuse PTFE plates of ˜6 mm thickness. One face of the box is chosen as the sample surface. The hollow light box had a diffuse reflectance of ˜0.83 measured at the sample surface (e.g. ˜83%, averaged over the 400-700 nm wavelength range, measurement method described below). During the gain test, the box is illuminated from within through a 1 cm circular hole in the bottom of the box (opposite the sample surface, with the light directed towards the sample surface from the inside). This illumination is provided using a stabilized broadband incandescent light source attached to a fiber-optic bundle used to direct the light (Fostec DCR-II with ˜1 cm diameter fiber bundle extension from Schott-Fostec LLC, Marlborough Mass. and Auburn, N.Y.). A standard linear absorbing polarizer (such as Melles Griot 03 FPG 007) is placed between the sample box and the camera. The camera is focused on the sample surface of the light box at a distance of ˜34 cm and the absorbing polarizer is placed ˜2.5 cm from the camera lens. The luminance of the illuminated light box, measured with the polarizer in place and no sample films, was >150 cd/m². The sample luminance is measured with the PR-650 at normal incidence to the plane of the box sample surface when the sample films are placed parallel to the box sample surface, the sample films being in general contact with the box. The relative gain is calculated by comparing this sample luminance to the luminance measured in the same manner from the light box alone. The entire measurement was carried out in a black enclosure to eliminate stray light sources. When the relative gain of film assemblies containing reflective polarizers was tested, the pass axis of the reflective polarizer was aligned with the pass axis of the absorbing polarizer of the test system. Relative gain values reported for prismatic films were generally obtained with the prism grooves of the film nearest the absorbing polarizer being aligned perpendicular to the pass axis of the absorbing polarizer.

The diffuse reflectance of the light box was measured using a 15.25 cm (6 inch) diameter Spectralon-coated integrating sphere, a stabilized broadband halogen light source, and a power supply for the light source all supplied by Labsphere (Sutton, N. H.). The integrating sphere had three opening ports, one port for the input light (of 2.5 cm diameter), one at 90 degrees along a second axis as the detector port (of 2.5 cm diameter), and the third at 90 degrees along a third axis (i.e. orthogonal to the first two axes) as the sample port (of 5 cm diameter). A PR-650 Spectracolorimeter (same as above) was focused on the detector port at a distance of ˜38 cm. The reflective efficiency of the integrating sphere was calculated using a calibrated reflectance standard from Labsphere having ˜99% diffuse reflectance (SRT-99-050). The standard was calibrated by Labsphere and traceable to a NIST standard (SRS-99-020-REFL-51). The reflective efficiency of the integrating sphere was calculated as follows:

Sphere brightness ratio=1/(1−Rsphere*Rstandard)

The sphere brightness ratio in this case is the ratio of the luminance measured at the detector port with the reference sample covering the sample port divided by the luminance measured at the detector port with no sample covering the sample port. Knowing this brightness ratio and the reflectance of the calibrated standard (Rstandard), the reflective efficiency of the integrating sphere, Rsphere, can be calculated. This value is then used again in a similar equation to measure a sample's reflectance, in this case the PTFE light box:

Sphere brightness ratio=1/(1−Rsphere*Rsample)

Here the sphere brightness ratio is measured as the ratio of the luminance at the detector with the sample at the sample port divided by the luminance measured without the sample. Since Rsphere is known from above, Rsample can be calculated. These reflectances were calculated at 4 nm wavelength intervals and reported as averages over the 400-700 nm wavelength range.

### Transmission Measurements:

Transmission measurements were collected by means of a BYK-Gardner haze meter (BYK-Gardner USA, Columbia, Md.). The transmission of the polarizer films mounted on glass was measured in triplicate with the polarizer immediately touching the light source of the instrument and the pass axis of the reflective polarizer film was aligned with the pass axis of the polarizer of the test system. The data was then divided by the transmission value of the polarizer itself to determine the amount of polarized light transmitted though the coated optical film samples.

### Ingredients Employed in the Examples

“HFPO-”, as used in the Examples, unless otherwise noted, refers to the end group F(CF(CF3)CF2O)ₐCF(CF3)- of the methyl ester F(CF(CF3)CF2O)ₐCF(CF3)C(O)OCH3, wherein a averages about 6.22, with an average molecular weight of 1,211 g/mol. It was prepared according to the method reported in U.S. Pat. No. 3,250,808 (Moore et al.), the disclosure of which is incorporated herein by reference, with purification by fractional distillation.

HFPO—C(O)N(H)CH₂CH₂CH₂N(H)CH₃ was prepared according to the procedure found in US Published Application No. 2005/0250921A1, Preparation FC1/AM1.

### Multi-functional Free-radically Polymerizable Materials Having High Fluorine

1. HFPO-TMPTA refers to the Michael's adduct of HFPO—C(O)N(H)CH₂CH₂CH₂N(H)CH₃ (FC1/AM1) with trimethylolpropane triacrylate (TMPTA). This adduct was made as described in US Published Application No. 2005/0250921A1, Example 1, as the preparation of an approximately 1:1 molar ratio adduct of FC1/AM1 with AC-1(TMPTA) or FC1/AM1/AC-1. This adduct has 52.02 wt-% fluorine and nominal Mn of 1563 g/mole.

2. C6DIACRY is the trade designation for 2,2,3,3,4,4,5,5-octafluoro-1,6-hexanediol diacrylate (commonly referred to as 8F-HDDA), having a molecular weight of 370.2 g/mole and at least 40 wt-% fluorine was obtained from Exfluor Research Corporation, of Round Rock, Tex.

3. CN 4000 was obtained from Sartomer Company, Exton, Pa.

4. Br-FKM (E18402) is a free-radically polymerizable amorphous terpolymer of tetrafluoroethylene (TFE), vinylidene fluoride (VDF) and hexafluoropropylene (HFP), and a halogen-containing cure site monomer having 70 wt. % fluorine, and available from Dyneon LLC of Oakdale, Minn.

A1106 is the trade designation for 3-aminopropyltrimethoxysilane, manufactured by Osi Specialties (GE Silicones) of Paris, France.

BYK-411 is the trade designation for a solution of a modified urea available from BYK Chemie, Wesel, Germany.

Darocur 4265 is the trade designation for a (mixture of 50% 2-hydroxy-2-methyl-1-phenyl-1-propanone and 50% 2,4,6 trimethylbenzoyl-diphenyl-phosphineoxide) UV photoinitiator obtained from Ciba Specialty Products, of Tarrytown, N.Y.

Darocur 1173 is the trade designation for 2-hydroxy-2-methyl-1-phenyl-1-propanone, a UV photoinitiator, and was obtained from Ciba Specialty Products, of Tarrytown, N.Y., and used as received.

Esacure ONE is the trade designation for difunctional alpha hydroxy ketone photoinitiator obtained from Lamberti Spa of Gallarate, Italy.

Irgacure 184 is the trade designation for a 1-hydroxy-cyclohexylphenyl ketone photoinitiator obtained from CIBA Specialty Chemicals, of Tarrytown, N.Y.

HMDS is the trade designation for hexamethydisilizane available from Aldrich Co.

KB-1 is the trade designation for a benzyl dimethyl ketal UV photoinitator obtained from Sartomer Company of Exton, Pa. and was used as received.

MBX-20 is the trade designation for beads made from a copolymer of methyl methacrylate and ethyleneglycol dimethacrylate obtained from Sekisui Chemical, Osaka, Japan

Nalco 2327 is the trade designation for an aqueous dispersion of 20 nm silica nanoparticles (41% solids in water, stabilized with ammonia), and was obtained from Nalco Chem. Co., of Naperville, Ill.

Prostab 5198 is the trade designation for 4-hydroxy-2,2,6,6-tetramethyl-1-piperidinyloxy (commonly referred to as 4-hydroxy-TEMPO), and was obtained from CIBA Specialty Chemicals, of Tarrytown, N.Y.

Perenol F-45 is the trade designation for a copolyacrylate leveling agent available from Cognis, of Dusseldorf, Germany.

Photomer 6010 is the trade designation for an aliphatic urethane acrylate oligomer obtained from Cognis, of Dusseldorf Germany.

3-methacryloxypropyltrimethoxysilane is available from Alfa Aesar, Ward Hill, Mass. (Stock # 30505) and was used as received.

SR295 is the trade designation for pentaerythritol tetraacrylate obtained from Sartomer Company, of Exton, Pa.

SR351 is the trade designation for trimethylolpropane triacrylate (TMPTA), and was obtained from Sartomer Company, of Exton, Pa.

SR399 is the trade designation for dipentaerythritol pentaacrylate (molecular weight of 525 g/mole), a non-fluorinated multifunctional (meth)acrylate monomer obtained from Sartomer Company, of Exton, Pa.

SR444C is the trade designation for pentaerythritol triacrylate (PET3A), a non-fluorinated multifunctional (meth)acrylate monomer obtained from Sartomer Company, of Exton, Pa.

SR494 is the trade designation for ethoxylated pentaerythritol tetraacrylate, ethoxylated pentaerythritol triacrylate from Sartomer Company, of Exton, Pa.

Vazo 52 is the trade designation for 2,2′,-azobis(2,4-dimethylpentane nitrile), a thermal free-radical initiator obtained from DuPont, of Wilmington, Del.

ZrO₂ sols (40.8% solids in water) was prepared were prepared in accordance with the procedures described in U.S. patent application Ser. No. 11/079,832 filed Mar. 14, 2005 that claims priority to U.S. patent application Ser. No. 11/078,468 filed Mar. 11, 2005. The resulting ZrO₂ sols were evaluated with Photo Correlation Spectroscopy (PCS), X-Ray Diffraction and Thermal Gravimetric Analysis as described in U.S. patent application Ser. Nos. 11/079,832 and 11/078468. The ZrO₂ sols used in the examples had properties in the ranges that follow:

| | PCS Data | | |
|---|---|---|---|
| | Intensity | Volume- | (Intensity- |
| Dispersion | avg size | avg size | avg)/(Volume- |
| Index | (nm) | (nm) | avg) |
| 1.0–2.4 | 23.0–37.0 | 8.0–18.8 | 1.84–2.97 |

| Relative Intensities | | Apparent Crystallite Size (nm) | | | | | Weighted |
|---|---|---|---|---|---|---|---|
| Cubic/ | | (C, T) | M | M | Avg M | | Avg XRD |
| Tetragonal | Monoclinic | (1 1 1) | (−1 1 1) | (1 1 1) | Size | % C/T | Size |
| 100 | 6–12 | 7.0–8.5 | 3.0–6.0 | 4.0–11.0 | 4.5–8.3 | 89%–94% | 7.0–8.4 |

### Surface Modified Zirconia Nanoparticles Formula 1

20.4 lbs of an aqueous dispersion of 10 nm zirconia nanoparticles (40.8% solids in water) was added to a 10 gallon reactor. 12.9 lbs additional water and 33.3 lbs 1-methoxy-2-propanol were added to the reactor with stirring. 2.5 lbs of 3-methacryloxypropyltrimethoxysilane was added slowly to the reactor with stirring. 0.021 lbs of a 5% solution in water of Prostab 5198 was added to the reactor with stirring. The mixture was stirred 18 hours at 80° C.

The reaction mixture was heated under vacuum (24-40 torr) and the 1-methoxy-2-propanol/water azeotrope was distilled off to remove substantially all of the water, while slowly adding 70.5 lbs of additional 1-methoxy-2-propanol. 0.4 lbs of 30% ammonium hydroxide was added to the reaction mixture, then the reaction was concentrated to 59.2% solids by distilling off 1-methoxy-2-propanol. The surface modification reaction resulted in a mixture containing 59.2% surface modified zirconia (ZrO₂—SM), by weight, in 1-methoxy-2-propanol. The final mixture was filtered through a 0.5 micron filter.

### Surface Modified Zirconia Nanoparticles Formula 2

ZrO₂ sol (207.4 g) was charged to a dialysis bag and dialyzed in 3500 g of de-ionized water for 6 hr. (sigma diagnostics tubing MWCO>1200 was used. The sol was isolated (34.03% solids) and used for the silane treatment.

The dialyzed ZrO₂ sol (80 g, 34.03% solids, 30.8% ZrO2) was charged to a 16 oz jar. Water (80 g) was charged with stirring. Methoxypropanol (160 g) and methacryloxypropyl trimethoxy silane (8.59 g) were charged to a 500 ml beaker with stirring. The methoxypropanol mixture was then charged to the ZrO₂ sol with stirring. The jar was sealed and heated to 90° C. for 3 hr 15 min. After heating the mixture was stripped to 170 g via rotary evaporation a white slurry was obtained.

De-ionized water (258 g) and concentrated NH₃ (5.7 g, 29 wt %) were charged to a one-liter beaker. The above concentrated sol was added to this with minimal stirring. The solids were isolated as a damp filter cake via vacuum filtration. The damp solids (82 g) were dispersed in methoxypropanol (200 g). The mixture was then concentrated (97 g) via rotary evaporation. Methoxypropanol (204 g) was added and the mixture concentrated (85.5 g) via rotary evaporation. Methoxypropanol was charged (205 g) and the mixture was concentrated via rotary evaporation. The final product 91.46 g was isolated at 27.4% solids. The mixture was filtered with a 1 um filter.

### Surface Modified Silica Nanoparticles for Low Refractive Index Formula 1

305 grams of Nalco 2327 was added to a 1-liter reaction flask. 486 grams of 1-methoxy-2-propanol was added to the reactor with stirring. 19.38 grams of 3-methacryloxypropyltrimethoxysilane was added slowly to the reactor with stirring. 0.15 grams of a 5% aqueous of Prostab 5198 was added to the reactor with stirring. The mixture was stirred 18 hours at 90° C.

The reaction mixture was heated under vacuum and the 1-methoxy-2-propanol/water azeotrope was distilled off with any necessary addition of 1-methoxy-2-propanol to remove substantially all of the water. The surface modification reaction resulted in a mixture containing 40% surface modified silica (Silica 20), by weight, in 1-methoxy-2-propanol.

### Surface Modified Silica Nanoparticles for Low Refractive Index Formula 2

15 g of 2327 (20 nm ammonium stabilized colloidal silica sol, 41% solids; Nalco, Naperville, Ill.) were placed in a 200-ml glass jar. A solution of 10 g of 1-methoxy-2-propanol (Aldrich) containing 0.47 g of 3-(trimethoxysilyl)propylmethacrylate (Gelest, Inc., Tullytown, Pa.) was prepared in a separate flask. The 3-(trimethoxysilyl)propylmethacrylate solution was added to the glass jar while the silica sol was stirred. The flask was then rinsed with an additional 5 ml of solvent and added to the stirred solution. After complete addition, the jar was capped and placed in an oven at 90 degrees Celsius for about 20 hours. The sol was then dried by exposure to gentle airflow at room temperature. The powdery white solid was collected and dispersed in 50 ml of tetrahydrofuran (THF) solvent. 2.05 g of HMDS (excess) were slowly added to the THF silica sol, and, after addition, the jar was capped and placed in an ultrasonic bath for about 10 hours. Subsequently, the organic solvent was removed by a rotovap and the remaining white solid heated at 100° C. overnight for further reaction and removal of volatile species.

### Fluoroacrylate Polymer Intermediate 1

A hyperbranched copolymer was made as follows. 17.01 grams of C6DIACRY, 8.51 grams of CN4000, 2.84 grams of SR399, 1.70 grams of HFPO-TMPTA, 241.02 grams of ethyl acetate, 25.52 grams of methyl ethyl ketone, and 3.40 grams of Vazo 52 predissolved in the methyl ethyl ketone were charged into a reaction vessel. It is preferable to add the HFPO-TMPTA to the CN4000 first, then the remaining reagents.

The contents of the reaction vessel were degassed under nitrogen, and then heated 80° C. in a sealed bottle for 1 to 1.5 hours. Care must be taken to avoid building an excessive molecular weight and gelling the reaction contents. The concentration of the reactive species in the reaction mixture, the temperature of the reaction, and the reaction time were all selected to ensure this result, and one or more of these would need to be adjusted if different reactive species were used.

The fluoroacrylate polymer intermediate solution obtained was analyzed by Gel Phase Chromatography/Size Exclusion Chromatography according to the test method previously described. FIG. 4 depicts the chromatograph obtained.

### Fluorinated Acrylate Monomer

A monomer mixture solution, incorporating a fluorinated acrylate monomer, was prepared as follows. 39.79 grams of C6DIACRY, 13.14 grams of CN4000, 22.52 grams of SR399, sufficient amount of the surface modified Silica dispersion to yield 45.05 grams solids (the silica dispersions typically had 35-55% solids after the azeotrope removal), and 4.50 grams of Darocur 1173 (a photoinitiator), were each separately dissolved in methyl ethyl ketone to yield 10% by weight solutions or dispersions. The first three solutions were then blended in the order indicated so that the monomers were well-blended before addition to the silica nanoparticles and the Darocur 1173 was added last.

### Low Refractive Index Formulation 1

1250 grams of the Fluorinated Acrylate Monomer composition was placed in a container and 300 grams the Fluoroacrylate Polymer Intermediate composition having 10% solids concentration was carefully added with thorough mixing to avoid aggregation of the silica. Coating of the Low Refractive Index Formulation was performed within one week of this preparation.

### Low Refractive Index Formulation 2

| | Surface Modified | | | | |
|---|---|---|---|---|---|
| Br-FKM (E | Silica | | | | Wt % F in |
| 18402) | Nanoparticles | SR399 | A1106 | KB-1 | Coating |
| 50 | 15 | 30 | 5 | 1.5 | 34.5 |

### Low Refractive Index Formulation 3

| | Surface Modified | | | |
|---|---|---|---|---|
| Br-FKM (E | Silica | | | Darocur |
| 18402) | Nanoparticles | SR399 | A1106 | 1173 |
| 55 | 10 | 30 | 5 | 2.0 |

### High Refractive Index Formula 1

A high refractive index coating solution was prepared by weighing the following into a jar: 6.94 g SR494 (ethoxylated pentaerythritol tetraacrylate), 5.60 g of a 10% solution of Darocur 1173 in IPA, and 23.86 g of IPA. The sample was shaken until all solids had dissolved. Then, 33.60 g of a surface modified zirconia formula 1 comprising 61% (ZrO₂—SM) and 39% 2-methoxy-1-propanol was added into the same jar. The solution was mixed until homogeneous. The resulting solution contained 40% solids in IPA and 2-methoxy-1-propanol.

### High Refractive Index Formula 2

A high refractive index coating solution was prepared by dissolving the following parts solids in ethyl acetate. The solution was mixed until homogeneous.

| Surface | | |
|---|---|---|
| Modified | | |
| Zirconia | | Darocur |
| Formula 2 | SR295 | 4265 % |
| 60 | 40 | 2 |

High Refractive Index Formula 3

A high refractive index coating solution was prepared by weighing the following into a jar: 2.98 g SR494 (ethoxylated pentaerythritol tetraacrylate), 0.24 g of Darocur 1173 and 11.79 g of IPA. The sample was shaken until all solids had dissolved. Then, 15.0 g of a surface modified zirconia formula 1 comprising 58.6% (ZrO₂—SM) and 41.4% 2-methoxy-1-propanol was added into the same jar. The solution was mixed until homogeneous.

### High Refractive Index Coating or Antireflective Coating on Reflective Polarizing Multilayer Film

A reflective polarizing substrate, the same as a commercially available from 3M Company under the trade designation “Vikuiti™ DBEF E” except that the thickness was 94 microns, was cut to a size of 7″×10″ and one pre-mask (printed with 3M logo) was removed to expose the surface for coating. The DBEF film was taped onto a plate of glass at both ends and sprayed with compressed air to rid the sample of debris. A wire-wound rod applicator (BYK-Gardner: AR4112) was placed on the film. A small amount (approx. 1 mL) of the high refractive index coating solution was syringe filtered (PALL: 0.45 μm GHP PN4560T) onto the surface of the DBEF directly before the wire wound rod. The rod applicator was used to immediately spread the solution evenly down the length of the film. When most of the solvent had evaporated, the coated film was removed from the glass plate and taped into an aluminum pan. The sample remained in the aluminum pan in the hood until all other solutions were coated. The samples were placed in the oven to dry at 100° C. for 2 min. The oven-dried coatings were polymerized by UV light (Fusion UV Systems Inc: MC6RQN) under nitrogen at 30 feet per minute (fpm), using an H bulb (Fusion UV: 525632H), exposing the sample one time. The UV output of received by the coating sample was measured (EIT, Inc.: UV Power Puck, S/N2001) as follows:

| UV-A | UV-B | UV-C | UV-V | Units |
|---|---|---|---|---|
| 1.693 | 1.794 | 0.200 | 1.201 | W/cm² |
| 0.525 | 0.492 | 0.059 | 0.370 | J/cm² |

An additional sample was prepared in the same manner as above, except that the same high refractive index composition was also coated at the same thickness on the opposite side (backside) of the DBEF (i.e. after removing the second pre-mask). This resulted in a DBEF film coated on both sides with a high refractive index layer.

The average thickness of the high index hard coat layer was 4 micrometers. The estimated refractive index (Est. RI) was measured as 1.62. This estimation is based on a refractive index calculated by percent volume and refractive index of individual components. The equation used to calculate the refractive index of the cured film is:

Coating RI=Σ[RI*Volume Fraction]

### The calculated refractive index is 1.62 based on the percent volume and refractive index of individual components.

For examples that employed an antireflective coating, the high refractive index coating was first applied and cured as just described. Then the indicated low refractive index coating (i.e. 1 or 2) was diluted with MEK to 3.5% solids to prepare it for coating. The high refractive index layer coated DBEF was taped onto a plate of glass at both ends and sprayed with compressed air to rid the sample of debris. A wire-wound rod applicator (BYK-Gardner: AR4104) was placed on the film. A small amount (approx. 0.5 mL) of the low refractive index solution was pipetted onto the surface of the HIHC directly before the wire wound rod. The rod applicator was used to immediately spread the solution evenly down the length of the film. When the solvent had evaporated, the coating was removed from the glass plate and taped in an aluminum pan. The coating remained in the aluminum pan in the hood until all other solutions were coated. The coating was placed in the oven to dry at 100° C. for 1 min. The oven-dried coating was polymerized by UV light (Fusion UV Systems Inc: MC6RQN) under nitrogen at 30 feet per minute, using an H bulb (Fusion UV: 525632H), exposing the sample twice (UV output data is available above). The average thickness of the low index layer was 95 micrometers.

A double sided AR sample was prepared in the same manner as above using the DBEF sample that had high refractive index layers on both sides. This double sided DBEF sample was coated with low refractive index formula 1 in the same manner as described above. This resulted in a DBEF film coated on both sides with an antireflective film having a high refractive index layer and a low refractive index layer coupled to the high refractive index layer.

### Antireflective Coating on Reflective Polarizing Multilayer Film with Beaded Layer (Gain Diffuser DBEF)

A reflective polarizing substrate, the same as a commercially available from 3M Company under the trade designation “Vikuiti™ DBEF E” except that the thickness was 94 microns, was provided with the pre-mask layers removed.

| | Weight | | Volume |
|---|---|---|---|
| | Parts | Density | Parts |
| Photomer | 100.0 | 1.08 | 92.6 |
| 6010 | | | |
| Esacure | 4.0 | 1.12 | 3.6 |
| ONE | | | |
| Perenol F- | 2.0 | 0.94 | 2.1 |
| 45 | | | |
| BYK 411 | 2.0 | 1.1 | 1.8 |
| MBX-20 | 183.0 | 1.2 | 153.2 |
| IPA | 356.8 | 0.787 | 453.3 |

| | Wt-% | Vol-% |
|---|---|---|
| Bead | 63.0 | 60.5 |
| Loading | | |
| Solid | 45.0 | 35.9 |

The beaded layer mixture described above was coated onto this substrate using a slot type die syringe pump. The coating width was 4″ and the substrate web was propelled at the speed of 15 fpm. Coating weight was controlled by controlling the amount of material expelled from the syringe pump characterized as flow rate. The coating weight was determined by direct measurement. Weight of the sample with a beaded layer was compared to weight of the substrate of the same size and from the same lot. The coated weight was 19.1 g/m².

The beaded DBEF film was taped onto a plate of glass at both ends with the beaded sided toward the glass plate and sprayed with compressed air to rid the sample of debris. A wire-wound rod applicator (BYK-Gardner: AR4112) was placed on the film. A small amount (approx. 1 mL) of the high refractive index coating solution was syringe filtered (PALL: 0.45 μm GHP PN4560T) onto the surface of the DBEF directly before the wire wound rod. The rod applicator was used to immediately spread the solution evenly down the length of the film. When most of the solvent had evaporated, the coated film was removed from the glass plate and taped into an aluminum pan. The sample remained in the aluminum pan in the hood until all other solutions were coated. The samples were placed in the oven to dry at 100° C. for 2 min. The oven-dried coatings were polymerized by UV light (Fusion UV Systems Inc: MC6RQN) under nitrogen at 30 feet per minute (fpm), using an H bulb (Fusion UV: 525632H), exposing the sample one time. The UV output of received by the coating sample was measured (EIT, Inc.: UV Power Puck, S/N2001) as follows:

| UV-A | UV-B | UV-C | UV-V | Units |
|---|---|---|---|---|
| 1.693 | 1.794 | 0.200 | 1.201 | W/cm² |
| 0.525 | 0.492 | 0.059 | 0.370 | J/cm² |

The average thickness of the high index hard coat layer was 4 micrometers. The estimated refractive index (Est. RI) was measured as 1.62.

The low refractive index coating formula 3 was diluted with MEK to 5.0% solids to prepare it for coating. The high refractive index layer coated DBEF was taped onto a plate of glass at both ends with the high refractive index surface exposed and sprayed with compressed air to rid the sample of debris. A wire-wound rod applicator (BYK-Gardner: AR4104) was placed on the film. A small amount (approx. 0.5 mL) of the low refractive index solution was pipetted onto the surface of the HIHC directly before the wire wound rod. The rod applicator was used to immediately spread the solution evenly down the length of the film. When the solvent had evaporated, the coating was removed from the glass plate and taped in an aluminum pan. The coating remained in the aluminum pan in the hood until all other solutions were coated. The coating was placed in the oven to dry at 100° C. for 1 min. The oven-dried coating was polymerized by UV light (Fusion UV Systems Inc: MC6RQN) under nitrogen at 30 feet per minute, using an H bulb (Fusion UV: 525632H), exposing the sample twice (UV output data is available above). The average thickness of the low index layer was 95 micrometers.

The Gain and Steel Wool Durability Testing using a 400 g weight was tested on each of the AR Coating and the results were as follows.

| | Gain | | | | Durability | Durability |
|---|---|---|---|---|---|---|
| Description | 1 | 2 | 3 | Average | (400 g, 10 rubs) | (400 g, 25 rubs) |
| DBEF with AR | 1.730 | 1.727 | 1.729 | 1.729 | 3 scratches, 2 | |
| Coating 1 | | | | | scratches | |
| DBEF with AR | 1.747 | 1.746 | 1.750 | 1.748 | | |
| Coating 1 on | | | | | | |
| both sides | | | | | | |
| DBEF with AR | 1.728 | 1.725 | 1.727 | 1.727 | 0 scratches, 0 | 0 scratches, 0 |
| Coating 2 | | | | | scratches | scratches |
| DBEF with | 1.705 | 1.707 | 1.708 | 1.707 | 0 scratches, 0 | 0 scratches, 0 |
| High Refractive | | | | | scratches | scratches |
| Index Coating 1 | | | | | | |
| DBEF with | | | | | 0 scratch, 0 scratch | |
| High Refractive | | | | | | |
| Index Coating 2 | | | | | | |
| Gain Diffuser | 1.852 | 1.854 | 1.854 | 1.853 | 1 partial scratch | |
| DBEF with | | | | | | |
| High Refractive | | | | | | |
| Index Coating 3 | | | | | | |
| Gain Diffuser | 1.888 | 1.884 | 1.888 | 1.887 | 2 partial scratches | |
| DBEF with AR | | | | | | |
| Coating 3 | | | | | | |
| Comparative | 1.855 | 1.857 | 1.861 | 1.858 | >50 scratches, >50 | |
| Gain Diffuser | | | | | scratches | |
| DBEF | | | | | | |
| Comparative | 1.709 | 1.709 | 1.710 | 1.709 | >50 scratches, >50 | |
| DBEF | | | | | scratches | |

Substantially the same results would be expected for “Vikuiti™ DBEF E” having a thickness of 132 microns.

Substantially the same durability results would be expected when AR Coatings 1, 2, or 3 are provided on a brightness enhancing film.

The transmission was tested of the reflective polarizing film coated with the antireflective film having low refractive index formulation 1. The results demonstrating the increase in transmission are as follows:

| | Raw | | | | Polarized | | | |
|---|---|---|---|---|---|---|---|---|
| | Transmission | | | | Transmission | | | |
| Description | 1 | 2 | 3 | Average | 1 | 2 | 3 | Average |
| DBEF with AR Coating 1 | 38.3 | 38.3 | 38.3 | 38.3 | 0.81 | 0.81 | 0.81 | 0.81 |
| DBEF with AR Coating 1 | 39.9 | 39.9 | 39.9 | 39.9 | 0.85 | 0.85 | 0.85 | 0.85 |
| on both sides | | | | | | | | |
| DBEF | 37.5 | 37.5 | 37.5 | 37.5 | 0.80 | 0.80 | 0.80 | 0.80 |

What is claimed is:

1. An optical film comprising
a reflective polarizing optical film comprising a high refractive index hardcoat layer coupled to the reflective polarizing optical film wherein the high refractive index surface layer exhibits less than 10 scratches after 10 rubs according to the Steel Wool Durability Test with a mass of 400 g.

2. The optical film of claim 1 wherein the high refractive index layer comprises surface modified inorganic particles having a refractive index of at least 1.60 dispersed in a crosslinked organic matrix.

3. The optical film of claim 2 wherein the surface modified inorganic particles comprise 5 vol-% to about 40 vol-% zirconia.

4. The optical film of claim 1 wherein the high refractive index hardcoat is formed from the reaction product of a polymerizable composition comprising non-fluorinated crosslinker comprising at least three (meth)acrylate groups.

5. The optical film of claim 1 wherein the reflective polarizing optical film is a multilayer film.

6. The optical film of claim 1 wherein the reflective polarizing optical film comprises two major surfaces and the high refractive index hardcoat is disposed on both major surfaces of the reflective polarizing film.

7. The optical film of claim 1 further comprising a microstructured optical film proximate the reflective polarizing optical film.

8. The optical film of claim 1 wherein the microstructured optical film comprises a repeating pattern of linear prisms.

9. The optical film of claim 1 wherein the prisms are disposed on a base substrate.

10. The optical film of claim 9 wherein the base substrate further comprises a high refractive index hardcoat layer on a surface of the base substrate opposing the prisms.

11. The optical film of claims 1 wherein the reflective polarizing optical film and the reflective polarizing film comprising the high refractive index hardcoat layer provide substantially the same gain.

12. An optical film comprising a reflective polarizing optical film comprising two major surface wherein a high refractive index hardcoat is disposed on the first major surface and a gain diffuser is disposed on the second major surface.

13. The optical film of claim 12 wherein the high refractive index layer exhibits less than 10 scratches after 10 rubs according to the Steel Wool Durability Test with a mass of 400 g.

14. The optical film of claim 12 wherein the gain diffuser comprises beads in a binder matrix.
